(19) United States
(12) Patent Application Publication
(10) Pub. No.: US 2016/0119922 A1
(43) Pub. Date: Apr. 28, 2016

(54) Device and Method of Handling Resource Availability of Unlicensed Band

(71) Applicant: HTC Corporation, Taoyuan City (TW)

(72) Inventor: Shiang-Rung Ye, Taoyuan City (TW)

(21) Appl. No.: 14/918,595

(22) Filed: Oct. 21, 2015

Related U.S. Application Data
(60) Provisional application No. 62/066,924, filed on Oct. 22, 2014.

(51) Int. Cl. H04W 72/04; H04W 16/14

(52) U.S. Cl. CPC H04W 72/0446; H04W 16/14

(57) ABSTRACT

A communication device for handling resource availability of an unlicensed band comprises a storage unit for storing instructions and a processing means coupled to the storage unit. The processing means is configured to execute the instructions stored in the storage unit. The instructions comprise determining that a first time period of a first cell of an unlicensed band is occupied according to a listen-before-talk (LBT) operation; and transmitting a message via a second cell to a network to notify that the first cell is occupied.

### CROSS REFERENCE TO RELATED APPLICATIONS

This application claims the benefit of U.S. Provisional Application No. 62/066,924, filed on Oct. 22, 2014 and incorporated herein by reference.

### BACKGROUND OF THE INVENTION

1. Field of the Invention

The present invention relates to a communication device and a method used in a wireless communication system and related communication device, and more particularly, to a communication device and method of handling resource availability of an unlicensed band in a wireless communication system.

2. Description of the Prior Art

A long-term evolution (LTE) system supporting the 3rd Generation Partnership Project (3GPP) Rel-8 standard and/or the 3GPP Rel-9 standard are developed by the 3GPP as a successor of the universal mobile telecommunication system (UMTS) for further enhancing performance of the UMTS to satisfy increasing needs of users. The LTE system includes a new radio interface and a new radio network architecture that provides high data rate, low latency, packet optimization, and improved system capacity and coverage. In the LTE system, a radio access network known as an evolved universal terrestrial radio access network (E-UTRAN) includes at least one evolved Node-B (eNB) for communicating with at least one user equipment (UE), and for communicating with a core network including a mobility management entity (MME), a serving gateway, etc., for Non-Access Stratum (NAS) control.

A LTE-advanced (LTE-A) system, as its name implies, is an evolution of the LTE system. The LTE-A system targets faster switching between power states, improves performance at the coverage edge of an eNB, increases peak data rate and throughput, and includes advanced techniques, such as carrier aggregation (CA), coordinated multipoint (COMP) transmissions/reception, uplink (UL) multiple-input multiple-output (UL-MIMO), licensed-assisted access (LAA) using LTE, etc. For a UE and an eNB to communicate with each other in the LTE-A system, the UE and the eNB must support standards developed for the LTE-A system, such as the 3GPP Rel-10 standard or later versions.

Network operators propose to offload network traffic of the LTE/LTE-A system to an unlicensed band, to ease load of the network traffic. For example, the eNB may provide services to the UE via the unlicensed band. However, available resource in the unlicensed band is usually dynamic, and it is not easy for the eNB to allocate the resource in the unlicensed band. The operations on the unlicensed band are even more complicated, when the UE operates on both a licensed band and the unlicensed band. The UE is not able to perform a (e.g., scheduled) transmission with the eNB, if resource in the unlicensed band is not available. The transmission may include a new transmission or a retransmission. The eNB operates incorrectly, if the scheduled transmission is not transmitted. For example, the eNB may combine received packets with empty transmission erroneously, and a worse result is obtained.

Thus, handling of resource availability of an unlicensed band is an important problem to be solved.

### SUMMARY OF THE INVENTION

The present invention therefore provides a communication device and method for handling resource availability of an unlicensed band to solve the abovementioned problem.

A communication device for handling resource availability of an unlicensed band comprises a storage unit for storing instructions and a processing means coupled to the storage unit. The processing means is configured to execute the instructions stored in the storage unit. The instructions comprise determining that a first time period of a first cell of an unlicensed band is occupied according to a listen-before-talk (LBT) operation; and transmitting a message via a second cell to a network to notify that the first cell is occupied.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system according to an example of the present invention.

FIG. 2 is a schematic diagram of a communication device according to an example of the present invention.

FIG. 3 is a flowchart of a process according to an example of the present invention.

FIG. 4 is a flowchart of a process according to an example of the present invention.

### DETAILED DESCRIPTION

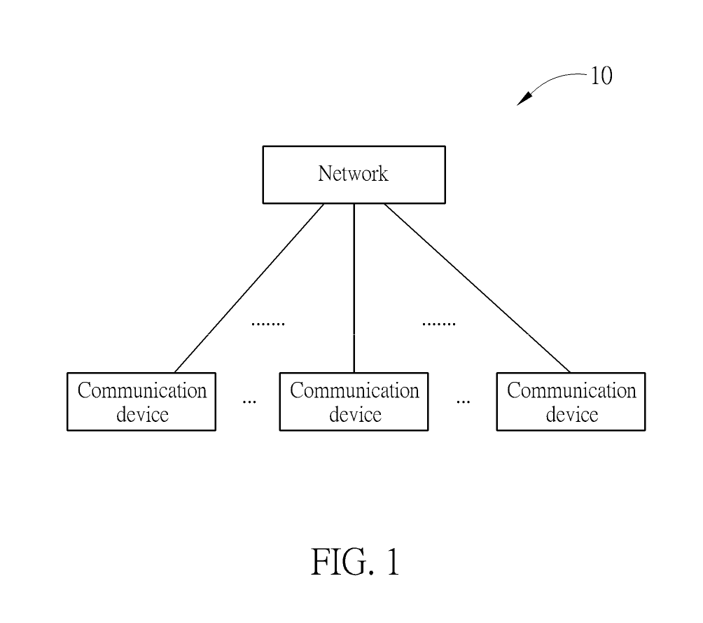

Please refer to FIG. 1, which is a schematic diagram of a wireless communication system 10 according to an example of the present invention. The wireless communication system 10 is briefly composed of a network and a plurality of communication devices. The network and a communication device may communicate with each other via one or more carriers of licensed band(s) and/or unlicensed band(s). The network and the communication device may simultaneously communicate with each other via multiple cells (e.g., multiple carriers) including a primary cell (e.g., primary component carrier) and one or more secondary cells (e.g., secondary component carriers). The abovementioned cells may be operated in the same or different duplexing modes, i.e. frequency-division duplexing (FDD) and time-division duplexing (TDD). For example, the primary cell may be operated on licensed carrier(s), while the secondary cell may be operated on unlicensed carrier(s).

In FIG. 1, the network and the communication devices are simply utilized for illustrating the structure of the wireless communication system 10. Practically, the network may be an evolved UTRAN (E-UTRAN) including at least one evolved NB (eNB) and/or at least one relay in a long term evolution (LTE) system, a LTE-Advanced (LTE-A) system or an evolution of the LTE-A system. The eNB or the relay may be termed as a base station.

A communication device may be a user equipment (UE), a low cost device (e.g., machine type communication (MTC) device), a device-to-device (D2D) device, a mobile phone, a laptop, a tablet computer, an electronic book, a portable computer system, a vehicle, or combination thereof. In addition, the network and the communication device can be seen as a transmitter or a receiver according to direction (i.e., transmission direction), e.g., for an uplink (UL), the communication device is the transmitter and the network is the receiver, and for a downlink (DL), the network is the transmitter and the communication device is the receiver.

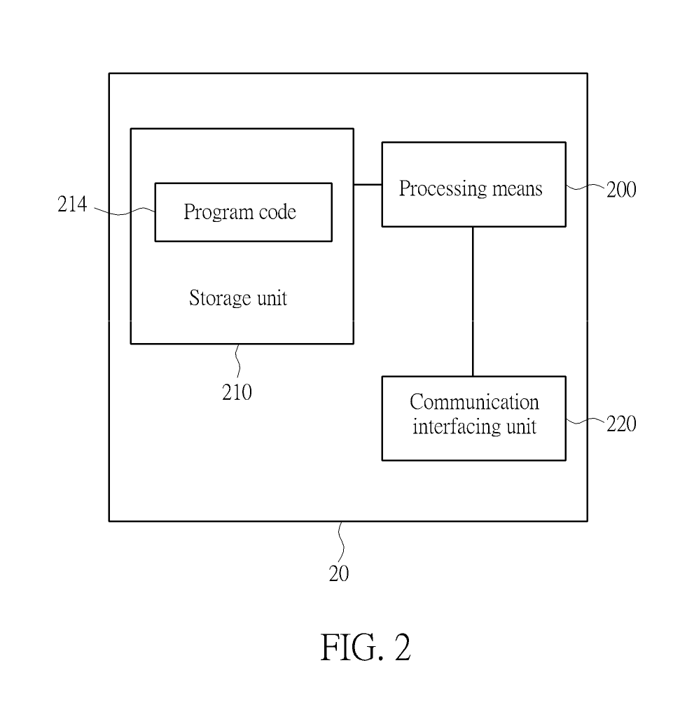

FIG. 2 is a schematic diagram of a communication device 20 according to an example of the present invention. The communication device 20 may be a communication device or the network shown in FIG. 1, but is not limited herein. The communication device 20 may include a processing means 200 such as a microprocessor or Application Specific Integrated Circuit (ASIC), a storage unit 210 and a communication interfacing unit 220. The storage unit 210 may be any data storage device that may store a program code 214, accessed and executed by the processing means 200. Examples of the storage unit 210 include but are not limited to a subscriber identity module (SIM), read-only memory (ROM), flash memory, random-access memory (RAM), Compact Disc Read-Only Memory (CD-ROM), digital versatile disc-ROM (DVD-ROM), Blu-ray Disc-ROM (BD-ROM), magnetic tape, hard disk, optical data storage device, non-volatile storage unit, non-transitory computer-readable medium (e.g., tangible media), etc. The communication interfacing unit 220 is preferably a transceiver and is used to transmit and receive signals (e.g., data, messages and/or packets) according to processing results of the processing means 200. For the sake of simplicity, UE is taken as an example of the communication device in the following embodiments. It should be noted that the scope of the invention is not limited thereto.

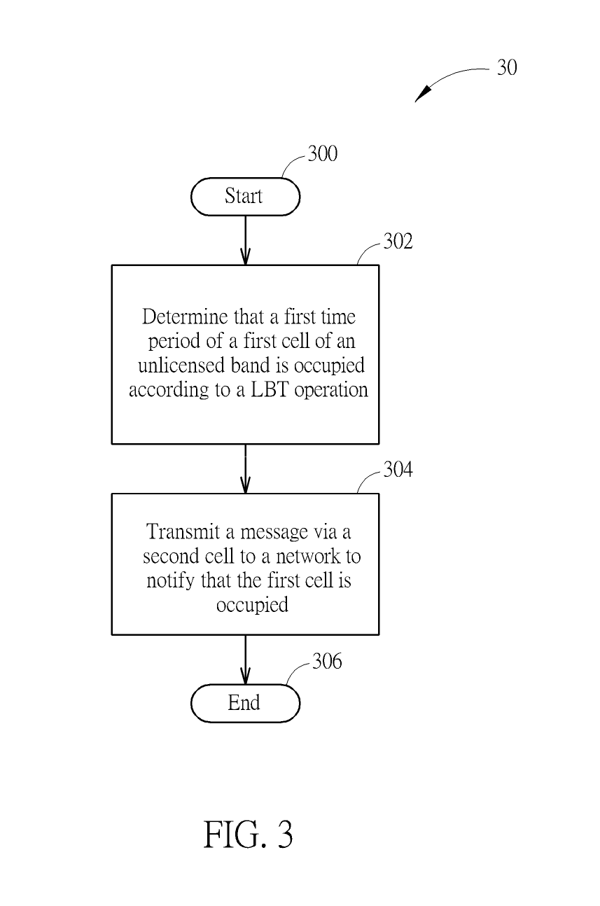

FIG. 3 is a flowchart of a process 30 according to an example of the present invention. The process 30 may be utilized in a communication device shown in FIG. 1, to handle resource availability of an unlicensed band. The process 30 may be compiled into the program code 214 and includes the following steps:

Step 300: Start.

Step 302: Determine that a first time period of a first cell of an unlicensed band is occupied according to a listen-before-talk (LBT) operation.

Step 304: Transmit a message via a second cell to a network to notify that the first cell is occupied.

Step 306: End.

According to the process 30, the communication device (e.g., UE) may determine that a first time period of a first cell (e.g., serving cell) of an unlicensed band is occupied according to a LBT operation (e.g., carrier sensing). The LBT is a technique that a device first senses a radio channel before it starts a transmission via the radio channel. If the radio channel has been used by other devices, the device is not allowed to perform the transmission. Then, the communication device may transmit a message via a second cell to a network (e.g., eNB) to notify that the first cell is occupied. That is, the communication device notifies the information of the first cell to the network such the network does not try to receive an empty transmission scheduled in the first time period (e.g., subframes) of the first cell. Thus, the network may operate correctly according to the message.

Realization of the process 30 is not limited to the above description.

In one example, the second cell may be in a licensed band, or may be in the unlicensed band. That is, the message may be transmitted in a cell of the licensed band which is more reliable, or may be transmitted in another cell of the unlicensed band which is in a lower traffic load state or in a state with a lower level of interference.

In one example, the message in the process 30 may be transmitted in a resource of the second cell, and the resource may be indicated by a physical DL control channel (PDCCH) transmitted by the network. In detail, when the network transmits a PDCCH in a subframe m to the communication device to request a UL (re)transmission, the PDCCH may also indicate a resource (e.g., physical resource) in a subframe (m+n) for transmitting the message, where the value n may be a predetermined value or may be configured by the network. If an automatic UL transmission is allowed for the communication device, the same resource assigned via the PDCCH is allocated for the communication device to transmit the message in a subframe (m′+n) for a non-adaptive retransmission, where the value m′ is determined according to when a physical hybrid automatic repeat request (HARQ) indicator channel (PHICH) is supposed to be received by the communication device.

In one example, the message in the process 30 may be transmitted in a resource of the second cell, and the resource may be configured by a radio resource control (RRC) message (e.g., RRCConnectionReconfiguration) transmitted by the network. Accordingly, the UE may transmit the message in a dedicated resource according to the RRC message. In one example, the message in the process 30 may include a medium access control (MAC) element comprising a field indicating an identity of the first cell. Accordingly, the network may know which cell is occupied according to the identity.

In one example, the communication device in the process 30 may further perform a backoff operation for a second time period, and may transmit information of the second time period to the network. Further, the second time period may include a plurality of subframes or a plurality of carrier-sensing slots. In detail, the communication device may perform a backoff procedure and may indicate how long the network has to wait (e.g., according to a length of a backoff time of the backoff procedure), before the network transmits a PDCCH to the communication device to request a new transmission or a retransmission. When receiving the PDCCH, the communication device may indicate how long the network has to wait (e.g., a length of the remaining backoff time) again, if the communication device is still in a backoff state of the backoff procedure. While waiting for the communication device, the network may assign a resource in the first cell that have been granted to the communication device to another communication device in order to use the resource efficiently.

In one example, the communication device in the process 30 may further perform a backoff operation, and may indicate a completion of the backoff operation to the network when the backoff operation is completed. That is, different from the previous example, the communication device notifies the end of the backoff operation to the network such that the network may not need to try to request a new transmission or a retransmission repeatedly. There are various ways of notifying the end of the back operation, and are described as follows.

In one example, the communication device may perform a random access procedure to indicate the completion of the backoff operation to the network. In detail, for a contention-based random access procedure, the network knows a backoff period of the backoff operation ends, when the network receives a message (e.g., msg3) transmitted by the communication device on the first cell. For a contention-free random access procedure, the network transmits a dedicated preamble to the communication device (e.g., by transmitting a MAC control element), after receiving the message from the communication device. The communication device starts the contention free random access procedure by using the dedicated preamble at the end of the backoff period. When the network receives the dedicated preamble, the network knows that the backoff operation is completed on the first cell.

In one example, the communication device may transmit a MAC control element including a field indicating an identity of the first cell to indicate the completion of the backoff operation to the network. A logic channel identify may be assigned to the MAC control element in order to distinguish the MAC control element in the present example from MAC control elements for other purposes. In one example, the communication device may transmit a physical layer signaling to indicate the completion of the backoff operation to the network. The physical layer signaling may be a dedicated signaling or a physical UL control channel (PUCCH).

In one example, the communication device may disable an automatic UL transmission on the first cell. That is, the communication device may disable the first cell which is determined to be occupied. Further, the automatic UL transmission may be for at least one HARQ process on the first cell. That is, the communication device may disable the automatic UL transmission for all the at least one HARQ process. In one example, the communication device may enable the automatic UL transmission on the first cell again, when the communication device receives a PDCCH transmitted by the network which indicates a transmission or receives a MAC packet data unit (PDU) indicating an identity of the first cell. In another example, the communication device may enable the automatic UL transmission on the first cell again, when the communication device receives a PDCCH transmitted by the network which indicates a transmission and the communication device is not in a backoff state of a backoff operation. That is, the automatic UL transmission may be enabled again, if any of the above conditions is satisfied.

It should be noted that although the examples are illustrated based on the process 30, to clarify the operations of the communication device. The examples can be combined and/or modified arbitrarily according to system requirements and/or design considerations. The following is an example illustrating a combination of the above description.

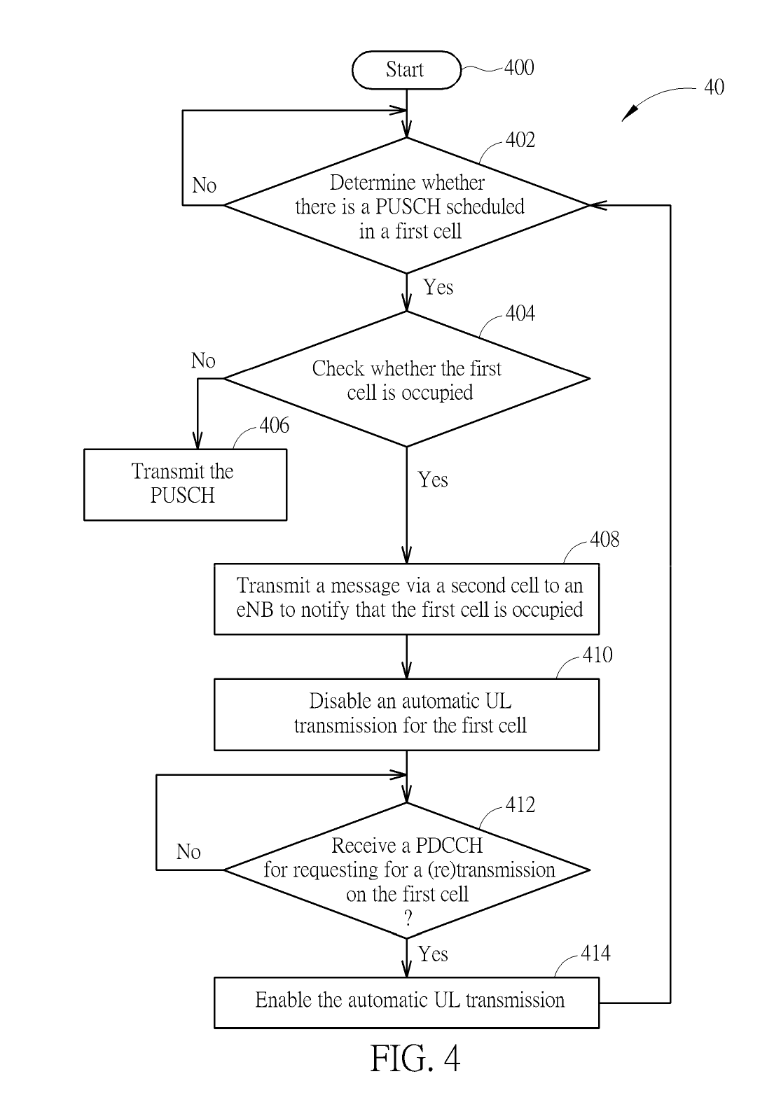

FIG. 4 is a flowchart of a process according to an example of the present invention. A UE starts to communicate with a network (step 400). The UE determines whether there is a PUSCH scheduled to be transmitted in a subframe x of a first cell of an unlicensed band according to a LBT operation (step 402). If yes, the UE proceeds to step 404; otherwise, the UE keeps waiting for a scheduled PUSCH. The UE checks whether the first cell is occupied within the subframes (x−y, x−y+z) (step 404), where (x−y+z) is preferably not greater than x. If the first cell is determined to be not occupied, the UE transmits the PUSCH in the subframe x (step 406). Otherwise, the UE determines that the first cell is occupied, and the UE transmits a message via a second cell to an eNB to notify that the first cell is occupied (step 408). The second cell may be in a licensed band, or may be another cell in the unlicensed band. In addition, the UE disables an automatic UL transmission for the first cell which has been enabled for a time period (step 410). Then, the UE waits for a PDCCH transmitted by the eNB which is for requesting for a (re) transmission on the first cell (step 412). If the PDCCH is received, the UE enables the automatic UL transmission (step 414), and proceeds to step 402 to prepare the transmission. Otherwise, the UE keeps waiting for the PDCCH.

Those skilled in the art should readily make combinations, modifications and/or alterations on the abovementioned description and examples. The abovementioned description, steps and/or processes including suggested steps can be realized by means that could be hardware, software, firmware (known as a combination of a hardware device and computer instructions and data that reside as read-only software on the hardware device), an electronic system, or combination thereof. An example of the means may be the communication device 20.

To sum up, the present invention provides a communication device and a method for handling resource availability of an unlicensed band. The communication device notifies a network that a resource of a cell of an unlicensed band is not available, if the communication device determines that the resource if occupied. Thus, the network operates correctly according to the information provided by the communication device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication device for handling resource availability of an unlicensed band, comprising:
a storage unit for storing instructions of:
determining that a first time period of a first cell of an unlicensed band is occupied according to a listen-before-talk (LBT) operation; and
transmitting a message via a second cell to a network to notify that the first cell is occupied; and
a processing means, coupled to the storage unit, configured to execute the instructions stored in the storage unit.

2. The communication device of claim 1, wherein the second cell is in a licensed band, or is in the unlicensed band.

3. The communication device of claim 1, wherein the message is transmitted in a resource of the second cell, and the resource is indicated by a physical downlink (DL) control channel (PDCCH) transmitted by the network.

4. The communication device of claim 1, wherein the message is transmitted in a resource of the second cell, and the resource is configured by a radio resource control (RRC) message transmitted by the network.

5. The communication device of claim 1, wherein the message comprises a medium access control (MAC) element comprising a field indicating an identity of the first cell.

6. The communication device of claim 1, wherein the storage unit further stores the instruction of:
performing a backoff operation for a second time period; and
transmitting information of the second time period to the network.

7. The communication device of claim 6, wherein the second time period comprises a plurality of subframes or a plurality of carrier-sensing slots.

8. The communication device of claim 1, wherein the storage unit further stores the instruction of:
performing a backoff operation; and
indicating a completion of the backoff operation to the network, when the backoff operation is completed.

9. The communication device of claim 8, wherein the communication device performs a random access procedure to indicate the completion of the backoff operation to the network.

10. The communication device of claim 8, wherein the communication device transmits a MAC control element comprising a field indicating an identity of the first cell to indicate the completion of the backoff operation to the network.

11. The communication device of claim 8, wherein the communication device transmits a physical layer signaling to indicate the completion of the backoff operation to the network.

12. The communication device of claim 1, wherein the storage unit further stores the instruction of:
disabling an automatic uplink (UL) transmission on the first cell.

13. The communication device of claim 12, wherein the automatic UL transmission is for at least one hybrid automatic repeat request (HARQ) process on the first cell.

14. The communication device of claim 12, wherein the storage unit further stores the instruction of:
enabling the automatic UL transmission on the first cell, when the communication device receives a PDCCH transmitted by the network which indicates a transmission or receives a MAC packet data unit (PDU) indicating an identity of the first cell.

15. The communication device of claim 12, wherein the storage unit further stores the instruction of:
enabling the automatic UL transmission on the first cell, when the communication device receives a PDCCH transmitted by the network which indicates a transmission and the communication device is not in a backoff state of a backoff operation.
